(19) United States
(12) Patent Application Publication
(10) Pub. No.: US 2023/0166340 A1
(43) Pub. Date: Jun. 1, 2023

(54) RFID ARRANGEMENTS FOR ROTATABLE WORK TOOLS

(71) Applicant: HUSQVARNA AB, Huskvarna (SE)

(72) Inventors: Robert Nyström, Göteborg (SE); Ulf Petersson, Tollered (SE); Fredrik Thorsell, Stockholm (SE); Pär Berglund, Vallentuna (SE)

(21) Appl. No.: 17/916,663

(22) PCT Filed: Apr. 1, 2021
(86) PCT No.: PCT/SE2021/050300

§ 371 Date: Oct. 3, 2022

(30) Foreign Application Priority Data
Apr. 6, 2020 (SE) 2050383-5

(51) Int. Cl. B23B 35/00; B23B 51/04

(52) U.S. Cl. CPC B23B 35/00; B23B 51/04; B23B 2270/36

(57) ABSTRACT

A drilling machine (120) for a core drill (100), the drilling machine comprises a motor arranged to power a spindle, the spindle comprising a drill bit interface (121 ) arranged to hold a drill bit (110) and to rotate the drill bit (110) about an axle of rotation (101 ), the drilling machine (120) comprising a tag reader (125) connected to a reader coil, wherein the reader coil is arranged at the drill bit interface (121 ) and surrounding the spindle to inductively couple to a tag coil arranged on the drill bit, the drilling machine (120) further comprising a drilling machine control unit (140) connected to the tag reader (125), wherein the drilling machine control unit is arranged to read data associated with the drill bit (110) via the inductively coupled reader and tag coils, thereby obtaining information about the drill bit.

### TECHNICAL FIELD

The present disclosure relates to rotatable work tools such as core drilling machines. There are disclosed methods and devices for transferring data between drill bit and drilling machine via inductively coupled coils, and also methods for controlling a drilling machine based on the transferred data.

### BACKGROUND

Radio-frequency identification (RFID) technology uses electromagnetic fields to automatically identify and track tags attached to objects. The tags often contain electronically stored information such as identification data (ID). While active tags have a local power source (such as a battery) and may operate hundreds of meters from the RFID reader, passive tags collect energy from a nearby RFID reader’s interrogating electromagnetic field and therefore has a reduced range. Unlike a barcode, the tag need not be within line of sight of the reader, so it may be embedded in the tracked object.

EP 2 460 623 A2 discloses example uses of RFID technology together with rotatable work tools. An RFID tag is for instance attached to a cut-off disc, and a corresponding reader is arranged on the machine to receive a data transmission from the RFID tag comprising, e.g., information regarding the type of tool.

US 7,210,878 B2 discloses core drilling equipment arranged with a transponder system for querying identification means arranged on a core drill bit. The drilling machine is then controlled based on drill bit specific information obtained from the identification means.

However, there is a continuing need for more robust passive RFID arrangements suitable for core drilling equipment.

### SUMMARY

It is an object of the present disclosure to provide RFID tag and reader arrangements suitable for use with core drills, and also remote servers, wireless devices, and fleet management systems for cooperating with the herein disclosed RFID tags and RFID readers.

This object is at least in part obtained by a drilling machine for a core drill. The drilling machine comprises a motor arranged to power a spindle. The spindle comprises a drill bit interface arranged to hold a drill bit and to rotate the drill bit about an axle of rotation. The drilling machine also comprises a tag reader connected to a reader coil, wherein the reader coil is arranged at the drill bit interface and surrounding the spindle to inductively couple to a tag coil arranged around a drill bit shaft. The drilling machine further comprises a drilling machine control unit connected to the tag reader. The drilling machine control unit is arranged to read data associated with the drill bit via the inductively coupled reader and tag coils, thereby obtaining information about the drill bit.

Thus, advantageously, information related to a drill bit currently connected to the drilling machine is made available to the drilling machine control unit. Notably, the reader coil is arranged surrounding the spindle on the drilling machine, which means that the reader coil is within constant range from a tag coil wound around the drill bit shaft as the spindle rotates, thereby allowing communication between tag and reader regardless of spindle rotation angle. This makes for a robust communication link between drilling machine and drill bit. The herein disclosed tags and readers can be manufactured at low cost, e.g., based on a printed circuit board (PCB) implementation enclosed in a protective coating.

According to aspects, the drilling machine control unit is arranged to control drilling by the drilling machine in dependence of the data obtained from the drill bit. Several applications are enabled by the drill bit information which is made available to the control unit. For instance, the drilling machine operation can be controlled to reduce risk of cutting segment glazing. Inventory management, service planning, and the like can also be made more efficient.

According to aspects, the drilling machine control unit is arranged to be connected via wireless link to a remote server and/or to a wireless device. This way an inventory of drilling machines can be maintained, and the status of individual units can be kept up to date. The remote server and/or wireless device can be used to keep track of different drilling machines, which is an advantage.

According to aspects, the reader coil is arranged to generate an H-field having an asymmetric field strength about the axle of rotation. This way the rotation speed of the spindle can be detected by monitoring the H-field strength as the spindle rotates. The reader coil may for instance comprise at least one magnetic material or ferrite slab arranged along a section of the coil, thereby generating the H-field having asymmetric field strength about the axle of rotation. The reader coil may also be wound along an asymmetric path about the axle of rotation, thereby generating the H-field having asymmetric field strength about the axle of rotation. The detection can be efficiently and reliably performed based on, e.g., a Fourier transform analysis.

According to aspects, the drilling machine control unit is arranged to determine a rotation speed of the spindle based on a periodic reader coil impedance variation during rotation of the spindle. This way of determining rotation speed does not rely on the drill bit comprising a reader tag, which is an advantage since it can be used with legacy drill bits. For instance, a variation in drill bit shaft radius can be used to detect spindle speed. Such variations in drill bit radius is commonly found on drill bit shafts as flat surfaces configured to mate with spanners or wrenches for fixing the drill bit to the drilling machine spindle.

According to aspects, the reader coil is arranged for asymmetrical coupling with the tag coil during a rotation of the spindle, thereby changing the reluctance seen by the reader coil flux during rotation of the spindle. This way the rotational speed of the spindle and drill bit can be determined. The tangential velocity of the drill bit cutting segments can then be determined based on the drill bit diameter.

According to aspects, the drilling machine control unit is arranged to determine the rotation speed of the spindle based on a voltage or current associated with the motor. This way the rotational speed of the spindle and drill bit can be determined in an alternative or complementary way. The tangential velocity of the drill bit cutting segments can then be determined based on the drill bit diameter, which is an advantage.

According to aspects, the drilling machine control unit is arranged to obtain information related to a diameter of the drill bit based on the data associated with the drill bit read via the inductively coupled reader and tag coils. The drill bit diameter can be used to translate spindle speed into cutting segment tangential velocity, which is an important parameter to be controlled for effective core drilling. The drilling machine control unit may for instance be arranged to determine the tangential velocity based on an obtained rotation speed of the spindle and on the diameter of the drill bit.

According to aspects, the drilling machine control unit is arranged to obtain data related to a drill bit applied pressure, and to control drilling by the drilling machine based on the tangential velocity associated with the drill bit and on the drill bit applied pressure. This way a more efficient drilling operation can be obtained since the operation can be optimized for a target tangential velocity and applied drill bit pressure.

According to aspects, the drilling machine comprises a control unit arranged to compare the tangential velocity associated with the drill bit and the drill bit applied pressure to an undesired operating region comprising undesired combinations of tangential velocity and applied drill bit pressure, and to trigger an event in case the drilling machine is operating in the undesired operating region. This way the risk of glazing the cutting segments on a core drill bit can be reduced, which is an advantage. A more efficient drilling operation is therefore obtained.

According to aspects, the event comprises activating a warning light arranged in connection to the drilling machine, or on the drilling machine, and/or changing at least one out of the tangential velocity and/or the applied drill bit pressure to a combination outside of the undesired operating region. This way the risk of glazing the cutting segments on a core drill bit can be reduced, which is an advantage. A more safe and efficient drilling operation is thereby obtained.

According to aspects, the tag reader is connected to the reader coil via a variable impedance matching network. The drilling machine control unit and/or the tag reader is arranged to control the variable impedance network to optimize the inductive coupling between the reader coil and the tag coil. The variable impedance matching network can be used to accommodate tolerances in the manufacturing process to optimize RFID communication performance.

According to aspects, the drilling machine control unit is arranged to determine and to store drill bit usage information related to any of drill time, drill bit applied pressure, vibration, and temperature associated with the drill bit. This way a record of drill bit usage information for a given unit can be maintained. The record can be used to, e.g., plan servicing of the drill bits and drilling machines, and to replace drill bits as they wear out. The record may, e.g., be stored on a remote server and/or on a tag arranged on the drill bit.

According to aspects, the drilling machine control unit is arranged to execute an authentication procedure based on the data associated with the drill bit read via the inductively coupled reader and tag coils, thereby preventing unauthorized use of the drilling machine and/or unauthorized use of the drill bit. This way a fleet operator or the like can ensure that only authorized drill bits are used with the drilling machines, thereby preventing unauthorized use of drill bits.

The object is also obtained by a drill bit comprising a drill bit interface for interfacing with a spindle comprised in a drilling machine and for rotating about an axle of rotation. The drill bit comprises a tag connected to a tag coil arranged at the drill bit interface, wherein the tag coil surrounds the axle of rotation to inductively couple to a reader coil arranged on the drilling machine surrounding the spindle. The tag is arranged to transmit data to the reader coil via the tag coil.

Thus, advantageously, information related to the drill bit currently connected to a drilling machine is made available to the drilling machine control unit. The reader coil is arranged surrounding the spindle, which means that the reader coil is in constant range from a tag coil wound around the drill bit shaft as the spindle rotates, thereby allowing communication between tag and reader regardless of spindle rotation angle. This makes for a robust and low cost communication link between drilling machine and drill bit.

According to aspects, the tag coil comprises an electrically conducting element arranged in-between at least part of the tag coil and an axle of the drill bit.

The conducting element generates an increased surface conductivity of the material inside the tag coil perimeter. By using a conductive element with minimal resistivity the ohmic losses in the conductive material encircled by the tag coil can be minimized and the Q factor of the tag coil can be increased as compared allowing current to be induced in the surface of the drill bit which could have significantly higher resistivity than the conductive element.

According to aspects, the tag coil is arranged to generate an H-field having an asymmetric field strength about the axle of rotation. This asymmetric field strength can be used to detect spindle rotation speed, which is an advantage.

According to aspects, the tag is arranged to transmit information related to any of; a dimension and/or a diameter of the drill bit, a usage specification of the drill bit, a specification or property of the cutting segments of the drill bit, a temperature of the drill bit, a measured vibration level, and identification data, ID, associated with the drill bit, to the drilling machine via the inductive coupling between the tag coil and the reader coil arranged on the drilling machine. Thus, advantageously, information related to the drill bit is made available to, e.g., a control unit in the drilling machine and/or to a remote server.

According to aspects, the tag is arranged to determine and/or to store drill bit usage information associated with the drill bit, wherein the usage information is related to any of drilling time, drill bit applied pressure, drill bit tangential velocity, measured vibration, and measured temperature associated with the drill bit. This way a record of drill bit usage information for a given unit can be maintained. The record can be used to, e.g., plan servicing of the drill bits and drilling machines, and to replace drill bits as they wear out. The record may, e.g., be stored on a remote server and/or on a tag arranged on the drill bit.

There are also disclosed herein drilling systems, fleet management systems, control units and methods associated with at least some of the above-mentioned advantages. There is furthermore disclosed herein computer programs, computer readable media, computer program products associated with the above discussed advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIG. 1 shows an example core drilling machine with manual feed;

FIG. 2 illustrates details of an example drilling machine with attached drill bit;

FIGS. 3A-B shows different views of an example RFID coil arrangement;

FIG. 4 illustrates details of an example RFID tag coil;

FIGS. 5A-B illustrate a tag coil arranged offset with respect to a central axis;

FIG. 6 schematically illustrates a system model of an RFID system;

FIGS. 7A-B are graphs illustrating applied force vs. cutting segment velocity;

FIG. 8 shows an example core drilling machine with automatic feed;

FIGS. 9-11 are flow charts illustrating methods;

FIG. 12 shows an example control unit; and

FIG. 13 illustrates a computer readable medium;

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

It is appreciated that, although the techniques and concepts disclosed herein are mainly exemplified using a core drill, the techniques are in no way limited to this type of drill. The herein disclosed techniques can be applied to a wide range of rotatable work tools, such as other types of drills, lathes, and the like where a work tool is attached to a rotating spindle to rotate about a central axis, and where it is desired to wirelessly transfer information such as an ID or the like from a rotatable work tool to the machine.

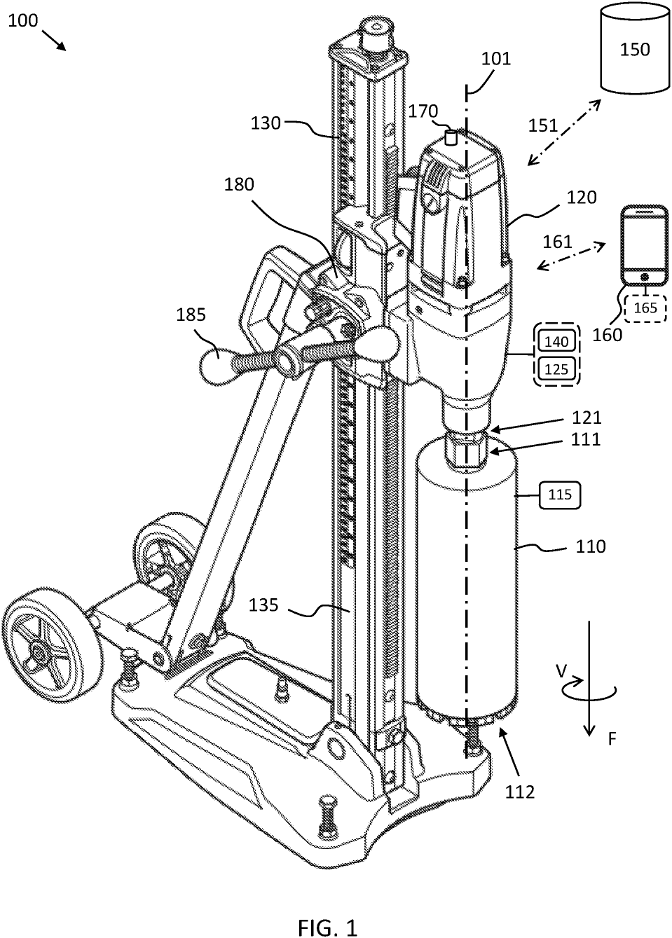

FIG. 1 shows a core drill 100 for cutting hard materials such as concrete and stone by a core drill bit 110 comprising cutting segments 112. The core drill bit 110 is powered by a drilling machine 120 comprising a motor arranged to power a spindle in a known manner. The drill bit 110 is attached to the spindle via a drill bit interface 111, 121.

During operation, the drill bit is rotated about an axle of rotation 101 and pushed into the material to be cut. The cutting segments 112 provide an abrasive action as the drill bit is pushed into the material. A cylindrical ‘core’ is then cut out from the material, which core is received inside the drill bit. Thus, the name ‘core’ drill.

The drilling machine is normally attached to a drill stand 130 arranged to guide the drill along a configurable drill path, i.e., at a pre-determined angle with respect to the material to be cut. The drill stand 130 can be used to generate a drill bit pressure, or force F, exerted by the cutting segments on the material which is abraded by pushing the core drill bit into the material to be cut.

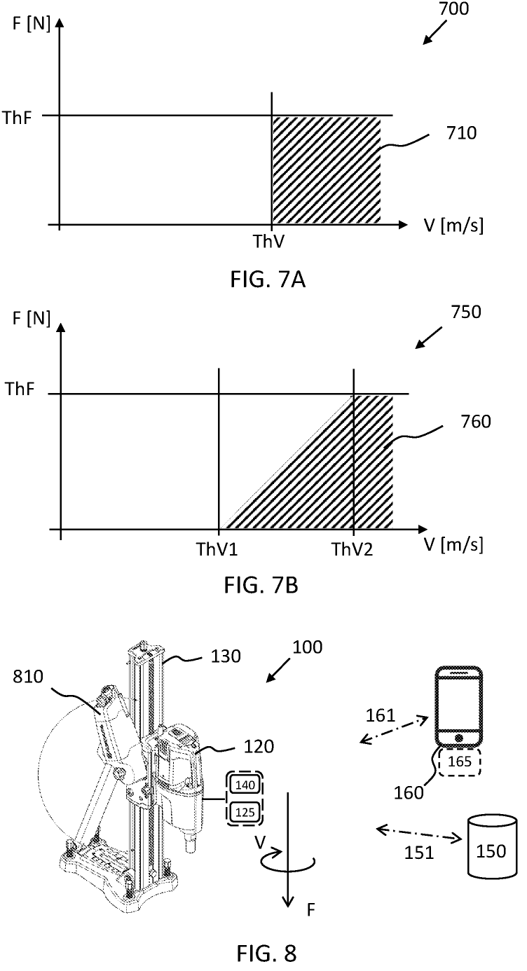

The drilling equipment illustrated in FIG. 1 is arranged to be manually operated by an operator turning the feed mechanism 185 to feed the drill bit into the material to be abraded. FIG. 7 shows a version comprising an automatic feed unit 810 arranged to control the force F.

The force F is normally measured in Newtons (N) or equivalently as a torque in Nm applied at the feed mechanism 185, or feed unit 810.

The force F can be automatically controlled by a control unit 140 connected to the automatic feed unit 810, or manually by an operator using the feed mechanism 185.

Core drilling equipment 100 such as that shown in FIG. 1 and in FIG. 8 is known in general and will therefore not be discussed in more detail herein.

The core drill bit 110 shown in FIG. 1 comprises an RFID tag 115 and the drilling machine 120 comprises a corresponding RFID reader 125 arranged to read out data from the tag 115. Both the tag 115 and the reader 125 are only schematically shown in FIG. 1 and will be discussed in more detail below.

The drilling machine 120 also comprises a control unit 140 connected to the reader 125. The control unit 140 and the reader may be implemented as separate units, or they can be integrated into the same circuit. The tag 115, the reader 125, and the control unit 140 are comprised in an RFID system. It is appreciated that the tag also comprises a circuit or control unit.

The reader 125 is arranged to read out data from the tag 115 and thereby allow the control unit 140 to, e.g., identify a given core drill bit. For instance, the tag 115 may transmit a unique identification sequence or signature in response to an interrogating field applied by the reader 125, which sequence or signature can be used by the control unit 140 to identify the core drill bit 110 and thereby distinguish it from other core drill bits. The tag 115 may of course transmit any type of data, such as tool dimensions or tool type. The data can be transmitted directly to the control unit, e.g., as a digital specification. An ID or index can also be transmitted which the control unit can use to index a database to obtain the desired information.

Some RFID technologies use magnetic induction between two loops or coil antennas located within each other’s near field, effectively forming an air-core transformer, for communication. Such systems often operate within the globally available and unlicensed radio frequency ISM band around 13.56 MHz. Theoretical working distance with compact standard antennas is up to 20 cm or so but the practical working distance is normally about 10 cm. This distance is more than enough for communicating between, e.g., a core drill bit 110 and a drilling machine 120. In a passive mode of operation, an initiator device (the reader) generates a carrier field and a target device (the tag) ‘answers’ by modulating the carrier field. In this passive mode, the target device may draw its operating power from the initiator-provided magnetic field, thus effectively making the target device a transponder. The present RFID system 115, 125 operates according to this magnetic induction principle of communication.

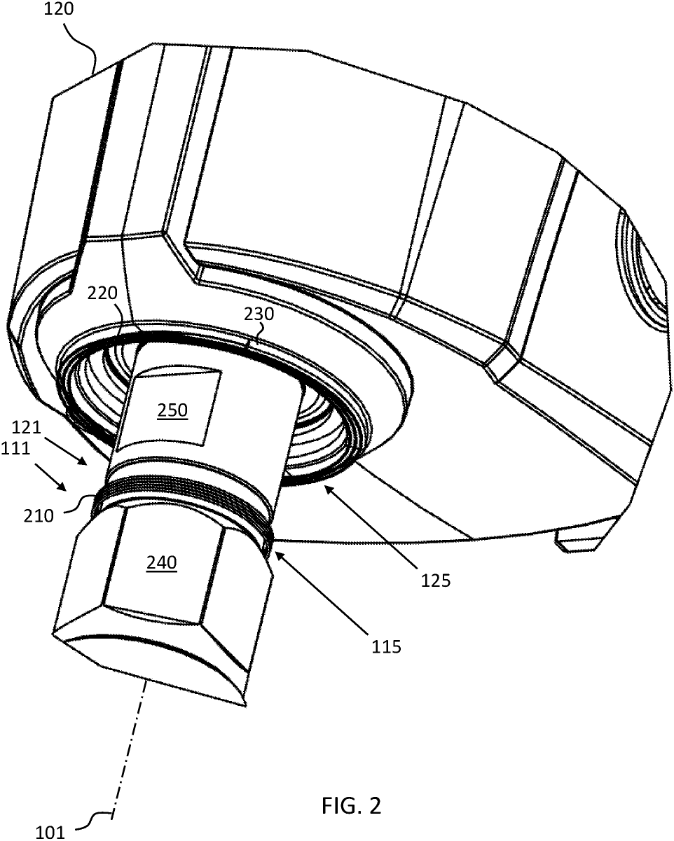

FIG. 2 illustrates a connection between drilling machine spindle and drill bit. The drill bit comprises a drill bit interface 111 arranged to mate with a corresponding drill bit interface 121 on the spindle of the drilling machine 120. The interface normally comprises a threaded portion, whereby the drill bit can be threaded onto the spindle and tightened by spanners or wrenches engaging with therefore intended flat surfaces 240, 250 arranged on the drill bit and on the spindle.

The tag 115 comprises a tag coil 210 wound around the or axle of rotation 101 of the drill bit 110. This tag 210 coil is located close to a reader coil 220 connected to the reader 125. The reader coil is wound around the spindle axle, i.e., about the same axle of rotation 101 as the tag coil. The distance between tag coil and reader coil is on the order of a few centimeters, thereby enabling RFID type communication based on magnetic induction between the tag and reader coils as discussed above.

Since the two coils are arranged about the axle of rotation, the tag is always in the near field of the reader, which is an advantage compared to designs where the tag periodically passes the reader, which is the case in at least some of the designs in presented in US 7,210,878 and in EP 2 460 623 A2.

A magnetic material slab 230 is arranged in connection to the reader coil 220 and follows the reader coil along a segment of its arcuate path. This magnetic material slab provides an asymmetry the nominal interrogating field of the reader 125 which enables detection of rotational velocity. This will be discussed in more detail below.

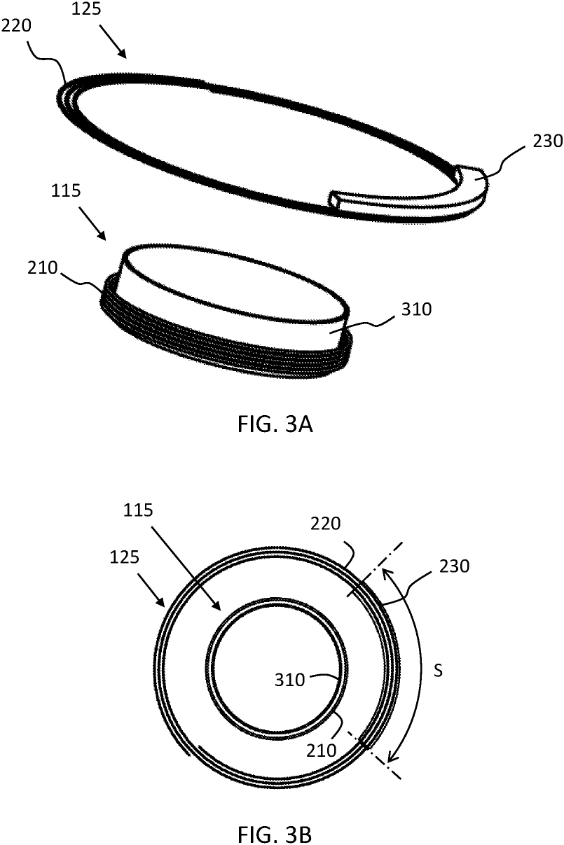

The magnetic material slab 230 is more clearly shown in FIGS. 3A and 3B, where FIG. 3A is a perspective view while FIG. 3B is a top view. This magnetic material slab provides an asymmetry in the interrogating field of the reader coil 220. The magnetic material slab 230 is arranged to extend along a section S of the reader coil. The section S is between 60 and 120 degrees, and preferably about 90 degrees.

A magnetic material slab is a piece of magnetic material with a high magnetic permeability used to confine and guide magnetic fields in electrical, electromechanical, and magnetic devices such as electromagnets, transformers, electric motors, generators, and inductors. It is made of ferromagnetic metal such as iron, or ferrimagnetic compounds such as ferrites. The high permeability, relative to the surrounding, causes the magnetic field lines to be concentrated in the core material. Thus, according to some aspects, the magnetic material slab is a ferrite slab.

The tag coil 210 illustrated in FIGS. 3A and 3B also comprises an electrically conducting element 310 arranged in-between at least part of the tag coil 210 and an axle of the drill bit. The electrically conducting element 310 may, e.g., comprise a copper foil or the like.

The conducting element 310 generates an increased surface conductivity of the material inside the tag coil perimeter. By using a conductive element 310 with minimal resistivity the ohmic losses in the conductive material encircled by the tag coil 210 can be minimized and the Q factor of the tag coil can be increased as compared allowing current to be induced in the surface of the drill bit which could have significantly higher resistivity than the conductive element 310.

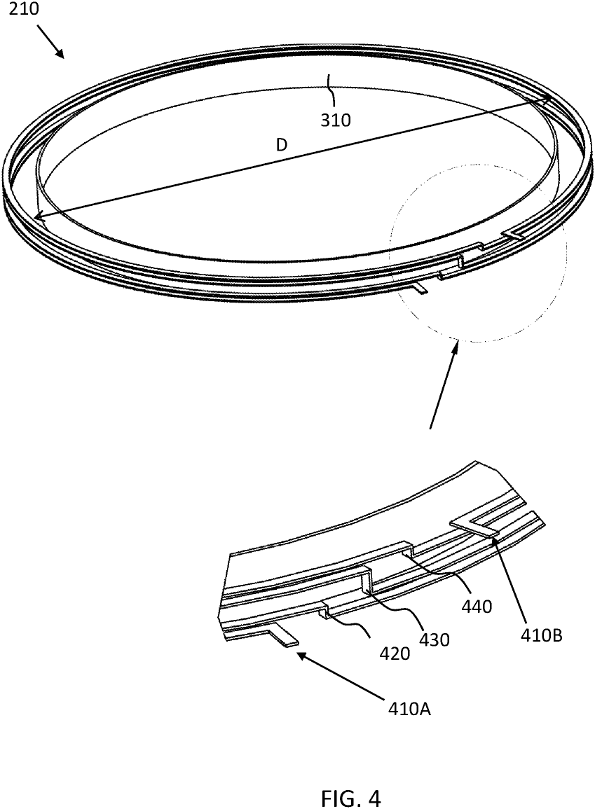

The tag coil 210 illustrated in FIG. 4 comprises four turns arranged in layers, where each of the bottom three layers connects to the layer immediately above by connecting segments 420, 430, 440 extending in a direction normal to the plane of the layer and the coil. Two terminals 410A, 410B are formed by the start of the first layer turn 410A and the end of the fourth layer turn 410B. These terminals constitute an interface to the coil. It is appreciated that a coil with less than four turns, and also more than four turns, can be realized in this manner. However, a coil with four turns have been found suitable for the applications discussed herein. An advantage with this type of layered coil structure is that the coil can be realized on a multi-layer printed circuit board (PCB) in a low cost manner. The PCB material also provides structural support for the coil, which is an advantage.

The same type of layered coil arrangement and PCB implementation can of course also be used for the reader coil 220.

A control unit implementing the various functions of the tag and the reader can be arranged on the same PCB as the coil, which allows for an efficient assembly of the tag and reader devices. The PCB combination of control unit and coil can be enclosed in a protective coating, to, e.g., provide a water sealed arrangement.

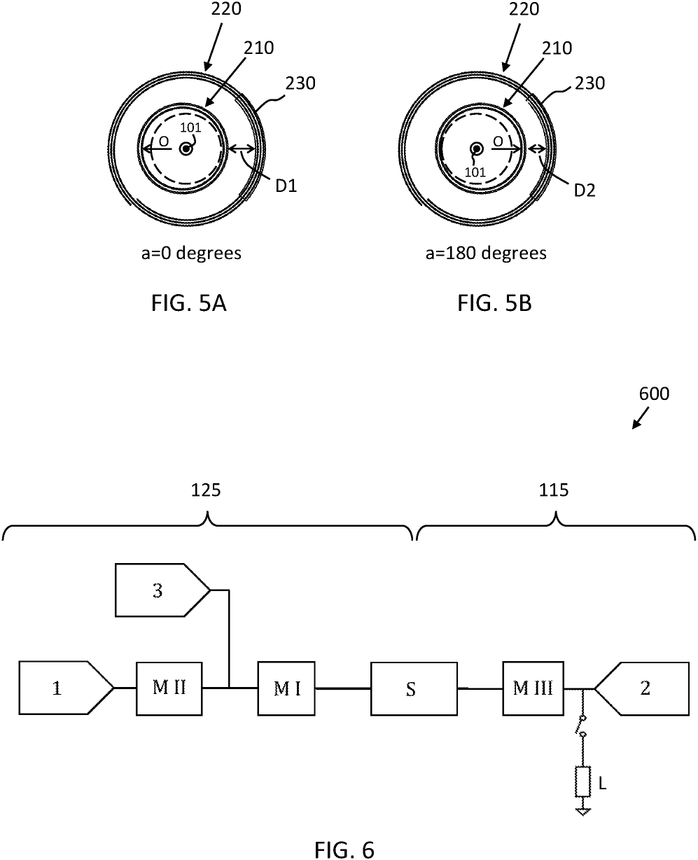

FIGS. 5A and 5B illustrate an example of a tag coil 210 which is arranged asymmetrically about the axle of rotation 101. FIG. 5A illustrates the situation when the rotation angle of the spindle is zero degrees, while FIG. 5B illustrates the situation when the rotation angle of the spindle is 180 degrees. The tag coil 210 in FIGS. 5A and 5B is arranged to generate an H-field having an asymmetric field strength about the axle of rotation 101. This asymmetric arrangement of the tag coil with respect to the reader coil allows for detecting a variation in impedance seen by the reader coil as the spindle rotates, which will be discussed in more detail below. This type of asymmetric tag arrangement therefore improves the estimation of spindle speed from the variation in impedance seen by the reader coil.

FIG. 6 shows a system model 600 of an inductive RFID system, such as the RFID system discussed herein. An inductive RFID system is often described simply as two inductively coupled coils. However, understanding the function of the system and closer evaluating system properties may require a more accurate model. The model 600 has three ports (labelled 1, 2 and 3 in FIG. 6) each associated with a respective characteristic impedance. Port 1 is the reader generator port. Port 2 is the Tag port and Port 3 is the reader receiver port. M I, M II and M III are impedance matching networks providing respective impedance transformations. At any given single frequency, each Port perceives the impedance of the matching networks as an RLC resonance circuit. S is a transfer function modeling the energy transfer between the reader and tag coil by means of their mutual inductance, i.e., a transformer.

The impedance as seen from Port 1 determines how much energy that is delivered to the system given an available voltage at the generator and the characteristic impedance of Port 1. In a real-world implementation the maximum power that can be delivered to the system may be limited by the maximum power that can be developed in the source impedance of the generator without compromising the integrity the generator circuit.

There are three things that determine the root-mean-squared (RMS) voltage at each of the ports: The impedance of each resonance circuit equivalent, the power that is delivered to the system and the transfer function S. The impedance of each resonance circuit equivalent is limited by its Q-factor. The transfer function of S is a function of the coils- and environments geometry and their respective Q factors. It is not directly a function of the individual inductances of the reader and tag coils.

The Q-factor (or Q) of a resonance circuit is the ratio of the peak energy stored in the circuit to the energy lost over one radian of a cycle. In line with this definition the Q-factor of lossy inductors and capacitors are defined as the ratio of the magnitude of the component’s reactance to its resistance. E.g. an inductor with a non-zero equivalent series resistance will therefore have a Q < ∞.

The downlink signaling (from reader to tag) is performed by varying the voltage and/or phase of the signal input to Port 1. The uplink signal (from tag to reader) is performed by switching in and out the shunt resistive or reactive load L connected to Port 2 thereby changing the Q and impedance of the resonance circuit equivalent as seen from Port 2. This method is often called load modulation and is known in general. This results in variations in the RMS voltage and/or phase seen by Port 3. Thus, by switching in and out the shunt resistive or reactive load L, communication between tag and reader is achieved.

Some key design features of the system implementation which contribute to determining the overall performance of the system is: The Q of the reader coil and tag coil, the impedance as seen by Port 1, the impedance as seen by Port 3 and the maximum power transfer ratio between the reader and tag coils.

The characteristic impedance of Port 1, the highest allowed power that can be developed internally in Port 1 and the characteristic impedance of Port 2 are characteristics that are set by choosing reader generator- and tag-circuits.

According to aspects, the tag reader 125 is connected to the reader coil 220 via a variable impedance matching network, wherein the drilling machine control unit 140 and/or the tag reader 125 is arranged to control the variable impedance network to optimize the inductive coupling between the reader coil 220 and the tag coil 210.

Inductive communication channels and methods of communication over such channels are known in general and will not be discussed in more detail herein.

One example tag architecture 1200 will be discussed below in connection to FIG. 12. The tag circuit 1200 may comprise, e.g., processing circuitry 1210, a storage medium 1230, and an interface for communications 1220. The interface communicates via the inductive loops with the reader 125 by modulating a load on the terminals of the tag coil 210.

A number of applications is enabled by the RFID communication connection between tag 115 and reader 125. Some of these applications also involve interactions with a remote server 150, and/or a wireless device 160 such as a smartphone or other portable electronic device shown in FIG. 1. For instance, a database may be maintained at the remote server 150 and/or at the wireless device 160. The control unit can then obtain an ID associated with a drill bit 110, and then transmit a request to the remote server or wireless device to obtain information associated with this particular ID from the database. The information can also be cached at the control unit 140.

According to some aspects, the drilling machine control unit 140 is communicatively coupled to the remote server 150 via wireless link 151. The remote server 150 may, e.g., be configured for fleet management of a collection of work tools. The remote server may also maintain inventory data based on tag 115 identifier data and monitor the tools in the inventory based on sensor output from the tags 115. For instance, the remote server 150 may maintain a database of different work tools, such as different core drill bits. The drilling machine 120 may obtain an ID from the core drill bit currently connected to it via the RFID arrangement discussed herein, and then obtain information related to the drill bit from the remote server 150 using the ID as key. The drilling machine can also upload information to the server 150, such as that a given drill bit is currently in use by the drilling machine 120. This enables, e.g., a fleet operator to track use of the tools in an inventory.

A wired connection from the drilling machine control unit 140 to the remote server 150 and/or to the wireless device 160 is of course also possible. This wired connection may, e.g., be realized by a USB connection or Ethernet connection, perhaps to an external modem or network.

According to an example use of the herein disclosed techniques, the control unit 140 is first configured with parameters related to a current drilling task, such as dimension of the hole to be cut, and potentially also the properties of material to be abraded by the cutting segments 112. An operator then attaches a drill bit 110 to the drilling machine 120, whereupon the control unit 140 connects to the drill bit tag 115 via the reader 125 and thereby receives an ID associated with the attached drill bit 110. The control unit can then compare a specification (perhaps downloaded from the remote server 150) of the current drill bit 110 with the configured parameters of the current drilling task. The control unit 140 may for instance prevent operation of the drilling machine or trigger a warning signal in case an erroneous drill bit has been attached, such as a drill bit with the wrong dimension for the hole to be cut or a drill bit with cutting segments unsuitable for the current drilling task.

The RFID system may also be connected to a wireless device 160, such as a smartphone or other type of user terminal via a wireless link 161. Some example wireless link technologies which may be suitable for connecting to the wireless device 160 comprise Bluetooth and Wi-Fi radio link technologies, such as the IEEE 802.11 family of communication systems. Infrared wireless link technology can also be used to connect a smartphone or other wireless device to the drilling machine, as well as wired connections, i.e., universal serial bus (USB) connections and the like. This wireless device 160 can be used by an operator to access data associated with the core drill bit 110 by communicating with, e.g., the control unit 140. The wireless device 160 may also be arranged to configure the drilling machine via the wireless link 161.

According to some aspects, with reference to FIG. 1, the wireless device 160 also comprises a reader 165 similar to the reader 125 arranged on the drilling machine 120. This enables the wireless device 160 to interact with core drill bits 110 which are not connected to a drilling machine 120 and therefore not accessible via the reader 125 on the drilling machine. This type of wireless device may, e.g., be used to interact with core drill bits in a storage facility, in order to simplify inventory maintenance. An operator may also more easily find the desired core drill bit in a store or warehouse since he or she can interrogate different core drill bits by the wireless device 160 in order to discern their individual properties.

An important parameter in core drilling is the tangential velocity V measured, e.g., in m/s, of the cutting segments 112. Tangential velocity is the component of motion along the edge of a circle measured at any arbitrary instant. As the name suggests, tangential velocity describes the motion of an object along the edge of this circle whose direction at any given point on the circle is always along the tangent to that point. The tangential velocity is determined by the angular velocity (measured in, e.g., radians per second) of the drill axle or spindle and the diameter or radius (measured in, e.g. mm) of the core drill bit 110. For example, the tangential velocity V can be determined as V=rw, where r is the radius of the core drill bit and ω is the angular velocity of the core drill bit, i.e., the spindle speed.

The angular velocity can be determined by the drilling machine control unit 140 in various ways, such as measuring current spindle speed. However, the diameter of the cutting tool depends on the type of core drill currently in use and is not so easy to determine without manual input. Manually inputting data to the system is often cumbersome and mistakes are easily made. It is an object of the present disclosure to reduce the need for manual input of data to the core drill system.

The angular velocity of the spindle and therefore also the tangential velocity V can be controlled by adjusting the rotation speed of the motor arranged to drive the spindle, or by controlling a transmission mechanism arranged between the motor drive shaft and the spindle. This transmission mechanism may, e.g., comprise a gearbox or a variable pulley belt drive. The control of the transmission mechanism can be performed automatically by the control unit 140 or manually by an operator using a manual control input device.

An important use of the RFID systems and core drilling equipment disclosed herein is to enable automatically determining the current core drill bit radius or diameter in order to be able to determine the tangential velocity of the cutting segments 112. This type of dimension data can be stored in the tag or otherwise associated with identification data stored in the tag, where it can be accessed by the drilling machine control unit 140 via the reader 125. For instance, as discussed above, if an ID or type specification of the drill bit 110 can be read out from the tag 115, then the dimensions and specification of the drill bit can be looked up in a database comprised in the control unit 140 or in the remote server 150. The dimension data, including diameter or radius of the drill bit, can of course also be read out directly from the tag 115. In other words, according to aspects, the drilling machine control unit 140 is arranged to obtain information related to a diameter or radius of the drill bit 110 based on the data associated with the drill bit 110 read via the inductively coupled reader and tag coils. The drilling machine control unit 140 may also be arranged to determine a tangential velocity associated with the drill bit 110 cutting segments 112 based on an obtained rotation speed of the spindle and on the diameter (or radius) of the drill bit.

Several applications where the RFID system 115, 125 can be used will be described below. For instance, sensors such as inertial measurement units (IMU), temperature sensors, shock sensors, and vibration sensors can be arranged in connection to the tag 115, the reader 125, and or the control unit 140. Data obtained from sensors on the drill bit 110 can be accumulated in the tag 115 where it can be accessed from the control unit 140. Data obtained from sensors arranged on the drilling machine 120 can be transmitted to the tag and stored there in order to create a use history associated with a given tag. A control unit 140 or other device such as the wireless device 160 may then access the history of a given drill bit 110 in order to discern, e.g., if it is time to replace the drill bit or if an event has occurred which warrants servicing the drill bit.

Thus, the drilling machine control unit 140 may be arranged to determine and to store drill bit usage information related to any of drill time, drill bit applied pressure, vibration, and temperature associated with the drill bit 110. This drill bit usage information can be used to, e.g., predict when a given drill bit needs to be replaced since it has been worn out. This prediction can be realized by, e.g., comparing the usage information to pre-determined threshold values. Unusual vibration patterns detected, e.g., by an IMU, may also indicate that something is wrong, and that an inspection is warranted. The drilling machine control unit 140 may update a data base entry associated with the drill bit 110 stored in a remote server 160 and/or stored in a wireless device 150. This update may, e.g., comprise new sensor data associated with the drill bit. This way an up to date record associated with an individual drill bit can be maintained. According to some aspects, the drilling machine control unit 140 is also arranged to send the drill bit usage information to a memory device comprised in the tag 115, via the inductive coupling between the reader coil 220 and the tag coil 210. The information is then stored locally in each tag 115, which means that a drill bit can be interrogated by means of, e.g., the wireless device 160 discussed above, even if no central record or database exists.

The system disclosed herein can also be used for authentication. Authentication of a given drill bit or work tool may be used to ensure that the correct work tool is used, that an operator has permission to use the work tool, and that a given work tool is allowed for use with a given drilling machine. According to some aspects, the drilling machine control unit 140 is therefore arranged to execute an authentication procedure based on the data associated with the drill bit 110 read via the inductively coupled reader and tag coils, thereby preventing unauthorized use of the drilling machine and/or unauthorized use of the drill bit.

According to some aspects, as discussed above, the tag 115 is arranged to store identification data. The identification data may, e.g., comprise an identification code or number which can be used to identify the type of object which the tag is attached to, or its owner. The identification data may furthermore comprise data to identify a production batch, a producer, a tool classification, or the like. The identification data may also store dimension data such as a work tool diameter, type, performance characteristics and material thickness which can be processed. The identification data may furthermore comprise data relating to intended use, i.e., an operational design regime of the tool and other tool specifications. The dimension data and data relating to intended use may support applications that prevent erroneous use of the construction equipment. For instance, a drilling machine may request data from an attached drill bit comprising information about an intended use. The drilling machine may then detect erroneous use and issue a warning signal or even prevent operation as long as the correct drill bit is not connected to the drilling machine.

The identification data may also comprise data relating to an owner of the tool, optionally in combination with authentication data. The authentication data and data relating to the owner of the tool can be used to prevent unauthorized use of the construction equipment and/or of the work tool.

An example realization of the tag control unit or tag circuit will be discussed below in connection to FIG. 12. This tag circuit 1200 may be equipped or connected to various forms of sensors or actuators. For instance, a temperature sensor, arranged to determine a temperature value associated with the work tool, may be configured to periodically sample a temperature value associated with the work tool, and store the data, or some function of the data such as maximum temperature, in the storage medium 1230. The reader 125 can then be used to access the stored temperature data in order to monitor, e.g., if the work tool has been subject to overheating or used in harsh environments associated with increased tool wear.

According to other aspects, the tag circuit 1200 can be arranged to determine an acceleration value, e.g., by means of an inertial measurement unit (IMU) integrated with or connected to the identification circuit. The IMU can be configured to determine a level of vibration currently experienced by the core drill bit 110. The measured data can be read out via the reader by, e.g., the drilling machine control unit 140. It is often possible to determine the type of material being cut by analysis of the vibrations measured by the IMU. In case the work tool is used to cut into a material for which it was not intended, a warning signal can be issued. Other forces and vibrations acting on the tool can also be determined and stored for later access. This way a historical analysis can be performed on a tool to see if the tool has been subject to unusually large forces or vibrations, or mechanical impact. The history of a given work tool can be used to estimate the remaining life-time of a given tool, which allows an operator or fleet management entity to replace the tool in time before it wears out entirely.

According to some other aspects, the tag circuit 1200 is arranged to receive data from the reader 125, and to store the data in the memory unit 1230. This enables, e.g., the reader 125, or a drilling machine control unit 140 connected to the reader 125, to measure operating time for a given tool, and to update a persistent operating time parameter of the tool. Certain events can also be stored and associated with different dates and time of day. For instance, strong vibration or high temperatures may be of interest when reviewing tool use.

A user can read out the operating time parameter and thereby obtain information about how long a given tool has been used. For this purpose, a separate reader device may be provided as a wireless device 160, e.g., as an application arranged to execute on a smartphone, tablet, or the like. This separate reader device may be arranged to interface with the tag 115, to power the tag 115, and to read out data from the tag 115, even if the drill bit is not connected to drilling machine comprising a reader 125.

The reader 125 and/or drilling machine control unit 140 may also determine one or more operating conditions and store this information in the tool, by the tag circuit. The operating conditions may, e.g., comprise a user identity or authorization code, a time of day, a date or day of the week, and the like. The separate reader device 160 can then be used to determine who has used a given tool, when, and for how long.

To summarize, FIGS. 1-4 show aspects of a drilling machine 120 for a core drill 100. The drilling machine comprises a motor arranged to power a spindle. The spindle comprises a drill bit interface 121 arranged to hold a drill bit 110 and to rotate the drill bit 110 about an axle of rotation 101. The drill bit interface may be an internally threaded portion arranged to receive a corresponding externally threaded portion on the drill bit. In this case the drill bit can be firmly attached to the spindle by spanner or wrench. However, a drill chuck or the like can also be used as drill bit interface. The present disclosure is not limited to any particular form of drill bit interface but can be used with a wide range of different interfaces. The motor in a core drill is normally an electric motor, which is arranged to apply torque to the spindle via a geared transmission. The spindle speed is normally adjustable.

The drilling machine 120 shown in, e.g., FIG. 1 comprises the tag reader 125 discussed above connected to a reader coil 220 (illustrated in, e.g., FIG. 2). The reader coil 220 is arranged at the drill bit interface 121 and surrounds the spindle to inductively couple to a tag coil 210 (also illustrated in FIG. 2) arranged on the drill bit 110. The reader coil 220 is wound about the axle of rotation 101. In the example shown in FIG. 2, both the tag coil 210 and the reader coil 220 are inductive loops formed along a substantially planar circular path. The tag coil 210 and the reader coil 220 are arranged to be inductively coupled to form an RFID communication link as discussed above.

The reader coil 220 and the tag coil 210 may be positioned close to highly conductive surfaces which through induced current distribution in the conductive surfaces increases the magnetic flux density which in turn increases the reluctance seen by the flux. This lowers the inductance of the coils. If the resistivity of the conductive surface is low the ohmic losses are low and the decrease in coil Q factor from the presence of the conductive surface approaches that proportional to the decrease in inductance as the resistivity goes towards zero. If the resistivity of the conductive surface is higher the ohmic losses in the surface also contribute to lowering the Q of the coil. In order to limit the decrease in Q to that directly dependent on the loss of inductance, the surface conductivity of metal surfaces can be increased by e.g. providing a thin copper layer on the metallic surface. The tag coil 210 as depicted in, e.g., FIGS. 2 and 3 utilizes this strategy to lower the resistivity of the drill bit by using a thin copper tube or film arranged between coil and the member around which the tag coil is wound with a small distance between the coil windings and said copper tube. The PCB tag coil 210 achieves the surface resistivity minimization by plating copper on the inside surface of the hole in the PCB.

The reader coil can be implemented as e.g. a planar three turn spiral coil with an inner diameter of about 66 mm and trace width of about 1 mm implemented on a PCB. The tag coil may be implemented as e.g. a four-turn helix coil as shown in FIG. 4 with a diameter about 2 mm larger than the outer diameter of the conductive element 310 which inner diameter would be identical to the outer diameter of the drill bit on which it is mounted with respect to tolerances to allow mounting the tag coil, including its conductive element, on said drill bit. The diameter of the drill bit in the section where the coil is mounted may be about 38 mm. The helix coil may be implemented on a PCB or as a wire wound coil.

The drilling machine 120 also comprises a drilling machine control unit 140 connected to the tag reader 125. An example architecture for this control unit will be discussed in more detail below in connection to FIG. 12. The drilling machine control unit 140 is arranged to read data associated with the drill bit 110 via the inductively coupled reader and tag coils according to the principles discussed above. The drilling machine control unit 140 thereby obtains information about the drill bit 110 currently connected to the drilling machine 120.

According to aspects, the drill bit is a core drill bit comprising cutting segments 112 for cutting stone and concrete. However, as noted above, although the techniques and concepts disclosed herein are mainly exemplified using a core drill 100, the techniques are in no way limited to this type of drill. The present teachings can be applied to a wide range of rotatable work tools, such as other types of drills, lathes, and the like where a work tool is attached to a rotating spindle.

According to aspects, the drilling machine control unit 140 is arranged to control the drilling machine in dependence of the data read out from the tag 115. Examples of various control operations which can be performed by the control unit was discussed above. For instance, the data obtained from the tag 115 may relate to an intended use of the drill bit, or to an operating regime in terms of tangential velocity and/or applied drill bit pressure. The drilling machine control unit 140 may then issue a warning in case a drill bit is being used outside of specification. The drilling machine control unit may also prevent drilling operation in case the drill bit is being used in an incorrect way.

According to aspects, the drilling machine control unit 140 is arranged to be connected via wireless link 151, 161 to a remote server 150 and/or to a wireless device 160. Both the remote server 150 and the wireless device 160 were discussed above. The drilling machine control unit 140 may comprise or be connected to a communications transceiver arranged to communicate with a corresponding communications transceiver external to the drilling machine. The connection to the remote server 150 may, e.g., be realized as a cellular communications link to a radio base station and then onwards over a wired data communications network such as the Internet. A Wi-Fi link based on, e.g., the IEEE 802.11 family of standards may also be used. The wireless link 161 to the wireless device may also be realized as a Wi-Fi link based on the IEEE 802.11 family of standards. Bluetooth and infrared communications are also viable options. Of course, the control unit 140 may also comprise a cellular transceiver configured to access a communications network such as the fourth generation (4G) or fifth generation (5G) communications networks defined by the third generation partnership program (3GPP).

According to aspects, the reader coil 220 is arranged for radio frequency identification, RFID, communication in a 13.56 MHz RFID frequency band. The 13.56 MHz band is a commonly used band for RFID applications. The band is intended for industrial, scientific, and medical (ISM) purposes, and is available globally, which is an advantage. Signaling in this band is mainly targeted at short range communication, such as from 10 cm up to perhaps a meter or so. Some relevant standards which are available for use with the 13.56 MHz band include the ISO/IEC 14443 and ISO/IEC 15693.

According to aspects, the reader coil 220 is arranged to generate an H-field having an asymmetric field strength about the axle of rotation 101.

Any asymmetry in the spindle or drill bit about the axle of rotation changing the total reluctance for the asymmetric flux associated with the reader coil will change the inductance of the reader coil as a function of rotational orientation in reference to the reader coil about the axle of rotation. As the asymmetric spindles and/or drill bits orientation about the axle of rotation makes one full revolution with reference to the asymmetric flux from the reader coil the inductance of the reader coil will vary a corresponding full revolution. Depending on the characteristics of the asymmetry in the reader coil flux, spindle and/or drill bit, one full rotation of the spindle and/or drill bit may give rise to repetitive inductance response at a higher harmonic. I.e. one full rotation about the axle of rotation may give rise to one or more periods of inductance variation.

This asymmetric field strength enables measuring spindle speed by observing variation in coil impedance as the spindle rotates. By measuring the difference in impedance as seen by the reader as a function of rotational angle. The amplitude (and/or phase) of the carrier at the readers receiver port could be measured. The repetitive variation of carrier amplitude (and/or phase) could then be used to calculate the spindle speed.

The frequency of the variation in coil impedance is proportional to the spindle speed. Thus, according to aspects, the drilling machine control unit 140 is arranged to determine a rotation speed of the spindle based on a variation of impedance seen by the reader coil 220 during rotation of the spindle. This frequency of variation can be determined by, e.g., Fourier transforming (or Discrete Fourier transforming) a sampled variation in voltage or current measured between the terminals of the reader coil or elsewhere in the reader circuit.

Implementing the Discrete Fourier Transform can be done effectively using the Fast Fourier Transform (FFT) algorithm. Other correlative methods similar to Fourier Transform such as e.g. Discrete Cosine Transforms can also be used to establish the frequency content. Applying window functions on the sample sets allows for tradeoffs in amplitude vs. angle fidelity and frequency leakage. Zero padding is also a well-known method that can be used in order to increase the frequency resolution without using larger sample sets, which otherwise would increase measurement lag. When using the FFT method for performing the Fourier Transform zero padding can also be used to increase the number of samples up to the next power of two, thereby not being limited to sample a power of two samples. This enables for a better flexibility with respect to lag in the frequency measurements.

The asymmetry may also include the RFID tag coil arrangement, either as providing the only asymmetry associated with the spindle and drill bit about the axle of rotation or as providing additional asymmetry. If the tag coil also is designed and/or positioned in such a way with reference to the drill bit that the H-field from it also is asymmetric about the axle of rotation the coupling between the reader coil and the tag coil will vary over one full revolution of the tag about the axle of rotation. The variation of the impedance of the reader coil (220) associated to the tags load modulation will then vary over one full revolution of the drill bit and/or spindle about the axle of rotation. This variation could then be measured using circuitry demodulating the tag to reader communication.

To achieve an asymmetry in the nominal field of the reader 125, at least three options are plausible.

1) A magnetic material may be arranged between the reader coil and the drill machine housing (or any other low resistivity surface increasing the reluctance of the coil) on a section of the antenna. FIGS. 2-3 show the magnetic material slab 230 arranged in connection to a section S of the reader coil 210. FIG. 3 also shows terminals of the reader coil, which terminals may be connected to the reader circuit 125. This magnetic material provides a low reluctance path for the magnetic flux in this region. This low reluctance path increases the flux density beneath the part of the reader coil where the magnetic material is placed. Thus, according to some aspects, the reader coil 220 comprises at least one magnetic material slab 230, such as ferrite, arranged along a section S of the coil, thereby generating the H-field having asymmetric field strength about the axle of rotation 101. Other materials having properties similar to ferrite may also be used with a similar effect.

2) The reader antenna coil may be tilted with respect to a normal plane of the axle of rotation 101. The nominal maximum flux density is directed along the normal to the plane of the coil, thereby generating a stronger field on one side of the spindle axis.

3) Electrical shielding may be arranged between the reader coil and the drill machine housing on a section of the antenna. This increases the reluctance on the section, thus providing an asymmetry effect in a similar manner to the option with the magnetic material slab. Options 1 and 3 may be combined for an increased asymmetry effect.

According to aspects, the reader coil 220 is wound along an asymmetric path about the axle of rotation 101, thereby generating the H-field having asymmetric field strength about the axle of rotation 101.

In this case the reader coil 220 does not follow a symmetric circular path surrounding the spindle. Rather, the path is asymmetrical and designed to generate an asymmetrical H-field.

According to other aspects, the drilling machine control unit 140 is arranged to determine the rotation speed of the spindle based on a voltage or current associated with an operation of the motor. This data can be sampled by the control unit 140, or by a circuit connected to the control unit 140. The rotation speed of the spindle can of course also be measured by a sensor arranged in connection to the spindle, such as a Hall effect sensor or the like.

Of course, the spindle speed can also be measured by other known sensor types for measuring axle rotation speed. One such example of an axle speed sensor is a Hall sensor. A Hall effect axle speed sensor uses the Hall effect to produce a square wave output in response to magnetic field disturbances caused by a rotating pulse wheel mounted around a hub or driveshaft.

FIG. 1 also shows a drill bit 110 comprising a drill bit interface 111 for interfacing with a spindle comprised in a drilling machine 120 and for rotating about an axle of rotation 101. The drill bit 110 comprises a tag 115 connected to a tag coil 210 arranged at the drill bit interface 121. The tag coil 210 surrounds the axle of rotation to inductively couple to a reader coil 220 arranged on the drilling machine 120. The tag 115 is arranged to transmit data to the reader coil 220 via the tag coil 210. According to aspects, the tag coil 210 is arranged for radio frequency identification, RFID, communication in a 13.56 MHz RFID frequency band. However, other operating bands are of course also possible to use with the RFID system described herein.

According to aspects, the drill bit is a core drill bit comprising cutting segments 112 associated with a tangential velocity.

According to aspects, the drill bit interface 111 comprises at least two opposing parallel surfaces 240 extending parallel to the axle of rotation 101, wherein the parallel surfaces are arranged to engage with a spanner or wrench for attaching and releasably fixing the drill bit 110 to the drilling machine 120.

The drill bit interface 121 on the spindle may also comprise at least two opposing parallel surfaces 250 extending parallel to the axle of rotation 101, wherein the parallel surfaces are arranged to engage with a spanner or wrench for attaching the drill bit 110 to the drilling machine 120.

The tag 115 is optionally arranged to transmit information related to any of; identification data, ID, associated with the drill bit, a dimension and/or a diameter of the drill bit 110, a usage specification of the drill bit, a specification or property of the cutting segments of the drill bit, a temperature of the drill bit, and a measured vibration level to the drilling machine 120 via the inductive coupling between the tag coil 210 and the reader coil 220 arranged on the drilling machine 120. The ID of the drill bit is important for many different applications, as was discussed above. Knowing the ID, the drilling machine control unit 140 may access its memory to discover properties related to the drill bit, such as the type of cutting segments, the owner of the drill bit, and so on. The dimension and/or diameter of the drill bit may, for instance, be used to set a correct spindle speed in order to obtain a desired tangential velocity of the cutting segments. The usage specification may allow the control unit 140 to issue a warning signal if the wrong type of core drill bit has been connected to the drilling machine for a given drilling purpose. The control unit 140 may even prevent drilling by the drilling machine in case the wrong type of core drill bit is attached to the drilling machine. The measured temperature and vibration can, e.g., be stored in the tag 115 or in the control unit 140 where it may describe the use history of the drill bit. This way it becomes possible to estimate the remaining lifetime of the drill bit, and to indicate when the cutting segments are likely in need of replacement. Also, the tag 115 may be arranged to determine and/or to store drill bit usage information associated with the drill bit 110, wherein the usage information is related to any of drilling time, drill bit applied pressure, drill bit tangential velocity, measured vibration, and measured temperature associated with the drill bit 110. This usage information serves as a record of use which is stored in the drill bit. A wireless device 160 can be used to read out the information, thereby allowing an operator to obtain a history of the tool he or she is currently using.

According to aspects, the tag 115 is arranged to receive drill bit usage information via the inductive coupling between the reader coil 220 and the tag coil 210, and to store the usage information in a memory device arranged on the drill bit 110. This way the usage information can be stored in the control unit, or even uploaded to the remote server 150.

In some case it may be advantageous to prevent unauthorized use of a given drill bit and drilling machine combination, or simply to prevent use of a drill bit which an operator is not allowed to use. Thus, according to some aspects, the tag 115 is arranged to execute an authentication procedure upon request from the drilling machine 120, thereby preventing unauthorized use of the drilling machine and/or unauthorized use of the drill bit.

FIGS. 7A and 7B are graphs 700, 750 of tangential velocity V in m/s and applied drill bit pressure F in Newtons.

Glazing refers to an effect where the abrasive cutting segments become dull and stop cutting. Glazing occurs when the cutting segment matrix holding the abrasive particles overheat and cover the abrading particles, i.e., the diamonds. The risk of glazing is a function of the applied drill bit pressure or force F and the tangential velocity V of the cutting segments 112. In particular, the risk of glazing increases if the drill bit is operated at high tangential velocity and low drill bit pressure. With higher drill bit pressure, a larger tangential velocity can normally be tolerated and vice versa. This means that there is an undesired operating region 710, 760 where the risk of glazing is increased. The size and shape of this undesired operating region depends on the type of cutting segment an on the material to be cut.

FIG. 7A illustrates an example 700 where the undesired operating region 710 is determined by two thresholds; A velocity threshold ThV and a force threshold ThF. In this case it is not desired to operate the core drilling machine for prolonged periods of time above ThV and below ThF. In case a tangential velocity above ThV is desired, then the drill bit force F should be increased to a value above ThF.

FIG. 7B illustrates another example 750 where the undesired operating region 760 starts at a first tangential velocity value ThV1 where the corresponding undesired drill bit applied force F increases gradually up to a threshold value ThF at a corresponding tangential velocity value ThV2.

In general, the thresholds and shape of the undesired operating region may vary with the type of cutting segment, and the type of material to be cut. The undesired operating region may also depend on the type of cooling used, such as the amount of water added during the drilling process.

To summarize, according to aspects, the drilling machine control unit 140 is arranged to obtain data related to the drill bit applied pressure, and to control drilling by the drilling machine 120 based on the tangential velocity associated with the drill bit and on the drill bit applied pressure. This way the risk of glazing can be reduced, by, e.g., automatically controlling the drilling machine to operate at a combination of applied drill pressure F and tangential velocity V where the risk of glazing is at an acceptable level, i.e., outside of an undesired operating region 710, 760. Different types of cutting segments are associated with different ranges of applied drill bit pressure and tangential velocity where there is a risk of glazing. These ranges, or information relating to these ranges, may according to some aspects be obtained from the tag 115, or from the remote server 150 where tables of properties associated with different types of cutting segments may be stored.

FIG. 1 illustrates an example core drilling machine 100 configured for manual operation, i.e., where an operator uses the manual feed mechanism 185 to feed the drill bit into the material to be cut. The drilling machine 120 in FIG. 1 comprises a control unit 140 configured to issue a warning signal by, e.g., the warning light 170 which is arranged to, e.g., blink with a strong red light. This warning signal indicates to an operator that there is a risk of glazing if the operator continues to operate the machine at the current combination of drill bit pressure and tangential velocity. The operator may then adjust operation parameters (applied pressure and/or drill bit speed) until the warning light turns off. Repeated warnings may prompt the operator to replace the drill bit or otherwise reconsider the drilling operation.

FIG. 8 illustrates an example core drilling machine 100 configured for automatic operation by an automatic feed unit 810. The feed unit is first configured by the control unit 140 with, e.g., a given drill rate and then started, whereupon it automatically performs the drilling operation. The automatic feed unit, and/or the control unit 140, is arranged to avoid operating the drilling machine at combinations of tangential velocity and pressure where there is a risk of glazing, such as in the undesired operating regions 710, 760. The avoiding can be realized by, e.g. increasing drill bit pressure F to accommodate the configured rotational velocity of the machine or reducing the tangential velocity V to better fit a configured drill bit pressure.

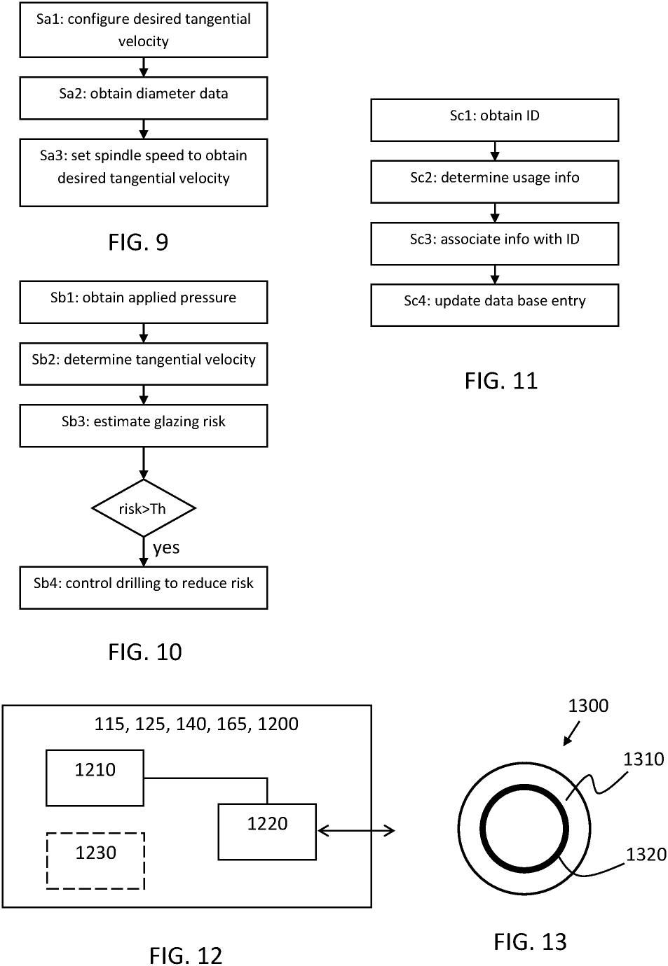

FIG. 9 shows a flow chart illustrating a method for operating a core drill 100. The method comprises configuring Sa1 a desired cutting segment tangential velocity V, obtaining Sa2 a diameter associated with a drill bit 110 connected to a drilling machine 120 of the core drill 100 via inductively coupled tag and reader coils 220, 210, and setting Sa3 a spindle rotation speed of the drilling machine 120 in dependence of the obtained diameter to obtain the desired tangential velocity.

This way, with reference to the discussion above, an operator or a control unit is able to configure tangential velocity directly without first having to manually convert the desired tangential velocity into spindle speed using the radius of the drill bit currently connected to the drilling machine. The operator simply configures the desired tangential velocity, whereupon the RFID system and drilling machine control unit 140 facilitates automatic conversion into spindle speed. The desired tangential velocity, or a range of allowable tangential velocities, may be obtained directly from the tag 115, or looked up at the remote server 150 using an ID read out from the drill bit via the RFID system.

FIG. 10 shows a flow chart illustrating another method for operating a core drill 100. The method comprises obtaining Sb1 a drill bit applied pressure F acting on a drill bit 110 of the core drill 100, determining Sb2 a cutting segment tangential velocity V associated with the drill bit 110, and estimating Sb3 a risk of cutting segment glazing based on the drill bit applied pressure and on the cutting segment tangential velocity. This method was discussed above in connection to FIGS. 7A and 7B. The drill bit applied pressure can be obtained from sensors arranged in connection to the drill stand 130, such as a torque sensor arranged in connection to an automatic feed unit. The tangential velocity can be determined as explained above by obtaining drill bit radius and spindle speed. The risk of cutting segment glazing can for instance be stored in a matrix or table indexed by tangential velocity and applied drill bit pressure.

If the estimated risk of cutting segment glazing is above a threshold, the method comprises controlling Sb4 at least one of the drill bit applied pressure and the cutting segment tangential velocity to reduce the risk of cutting segment glazing. This way the risk of cutting segment glazing can be reduced in an automated fashion.

FIG. 11 shows a flow chart illustrating yet another method for operating a core drill 100. The method comprises obtaining Sc1 an ID associated with a drill bit 110 connected to a drilling machine 120 of the core drill 100, determining Sc2 drill bit usage information associated with the drill bit 110, wherein the usage information is related to any of drilling time, drill bit applied pressure, drill bit tangential velocity, measured vibration, and measured temperature, associating Sc3 the drill bit usage information with the obtained ID, and updating Sc4 a data base entry associated with the drill bit 110 ID at a remote server 160 and/or at a wireless device 150, based on the drill bit usage information. This way a record of usage for an individual drill bit can be maintained. This record may facilitate drill bit servicing, replacement, and inventory tracking.

FIG. 12 schematically illustrates, in terms of a number of functional units, the general components of an identification circuit 1200, a drilling machine control unit 140, a tag 115 or a reader 125 according to embodiments of the discussions herein. Processing circuitry 1210 is provided using any combination of one or more of a suitable central processing unit CPU, multiprocessor, microcontroller, digital signal processor DSP, etc., capable of executing software instructions stored in a computer program product, e.g. in the form of a storage medium 1230. The processing circuitry 1210 may further be provided as at least one application specific integrated circuit ASIC, or field programmable gate array FPGA.

Particularly, the processing circuitry 1210 is configured to cause the device 115, 125, 140, 1200 to perform a set of operations, or steps, such as the methods discussed in connection to FIG. 6 and the discussions above. For example, the storage medium 1230 may store the set of operations, and the processing circuitry 1210 may be configured to retrieve the set of operations from the storage medium 1230 to cause the device to perform the set of operations. The set of operations may be provided as a set of executable instructions. Thus, the processing circuitry 1210 is thereby arranged to execute methods as herein disclosed.

The storage medium 1230 may also comprise persistent storage, which, for example, can be any single one or combination of magnetic memory, optical memory, solid state memory or even remotely mounted memory.

The device 115, 125, 140, 1200 may further comprise an interface 1220 for communications with at least one external device. As such the interface 1220 may comprise one or more transmitters and receivers, comprising analogue and digital components and a suitable number of ports for wireline or wireless communication.

The processing circuitry 1210 controls the general operation of the device 115, 125, 140, 1200, e.g., by sending data and control signals to the interface 1220 and the storage medium 1230, by receiving data and reports from the interface 1220, and by retrieving data and instructions from the storage medium 1230. In case of a tag or a reader, the interface comprises (or is connected via ports) to the inductive planar loops of either the tag 115 or the reader 125. Other components, as well as the related functionality, of the control node are omitted in order not to obscure the concepts presented herein.

FIG. 13 illustrates a computer readable medium 1310 carrying a computer program comprising program code means 1320 for performing the methods illustrated in any of FIGS. 9-11, when said program product is run on a computer. The computer readable medium and the code means may together form a computer program product 1300.

1. A drilling machine (120) for a core drill (100), the drilling machine comprises a motor arranged to power a spindle,
the spindle comprising a drill bit interface (121) arranged to hold a drill bit (110) and to rotate the drill bit (110) about an axle of rotation (101),
the drilling machine (120) comprising a tag reader (125) connected to a reader coil (220), wherein the reader coil (220) is arranged at the drill bit interface (121) and surrounding the spindle to inductively couple to a tag coil (210) arranged around a drill bit shaft,
the drilling machine (120) further comprising a drilling machine control unit (140) connected to the tag reader (125), wherein the drilling machine control unit is arranged to read data associated with the drill bit (110) via the inductively coupled reader and tag coils, thereby obtaining information about the drill bit (110).

2. The drilling machine (120) according to claim 1, wherein the drill bit is a core drill bit comprising cutting segments (112) for cutting stone and concrete.

3. The drilling machine (120) according to any previous claim, wherein the drilling machine control unit (140) is arranged to control drilling by the drilling machine (120) in dependence of the data.

4. The drilling machine (120) according to any previous claim, wherein the drilling machine control unit (140) is arranged to be connected via wireless link to a remote server (150) and/or to a wireless device (160).

5. The drilling machine (120) according to any previous claim, wherein the reader coil (220) is arranged for radio frequency identification, RFID, communication in a 13.56 MHz RFID frequency band.

6. The drilling machine (120) according to any previous claim, wherein the reader coil (220) is arranged to generate an H-field having an asymmetric field strength about the axle of rotation (101).

7. The drilling machine (120) according to claim 6, wherein the reader coil (220) comprises at least one magnetic material or ferrite slab (230) arranged along a section (S) of the coil, thereby generating the H-field having asymmetric field strength about the axle of rotation (101).

8. The drilling machine (120) according to claim 6 or 7, wherein the reader coil (220) is wound along an asymmetric path about the axle of rotation (101), thereby generating the H-field having asymmetric field strength about the axle of rotation (101).

9. The drilling machine (120) according to any of claims 6-8, wherein the drilling machine control unit (140) is arranged to determine a rotation speed of the spindle based on a periodic reader coil (220) impedance variation during rotation of the spindle.

10. The drilling machine (120) according to claim 9, wherein the reader coil (220) is arranged for asymmetrical coupling with the tag coil (210) during a rotation of the spindle, thereby changing the reluctance seen by the reader coil flux during rotation of the spindle.

11. The drilling machine (120) according to any previous claim, wherein the drilling machine control unit (140) is arranged to determine the rotation speed of the spindle based on a voltage or current associated with the motor and/or based on a rotation speed sensor arranged in connection to the spindle.

12. The drilling machine (120) according to any previous claim, wherein the drilling machine control unit (140) is arranged to obtain information related to a diameter of the drill bit (110) based on the data associated with the drill bit (110) read via the inductively coupled reader and tag coils.

13. The drilling machine (120) according to claim 12, wherein the drilling machine control unit (140) is arranged to determine a tangential velocity associated with the drill bit (110) based on an obtained rotation speed of the spindle and on the diameter of the drill bit.

14. The drilling machine (120) according to claim 13, wherein the drilling machine control unit (140) is arranged to obtain data related to a drill bit applied pressure, and to control drilling by the drilling machine (120) based on the tangential velocity associated with the drill bit and on the drill bit applied pressure.

15. The drilling machine (120) according to claim 14, comprising a control unit (140) arranged to compare the tangential velocity associated with the drill bit and the drill bit applied pressure to an undesired operating region (710, 760) comprising undesired combinations of tangential velocity and applied drill bit pressure, and to trigger an event in case the drilling machine is operating in the undesired operating region.

16. The drilling machine (120) according to claim 15, wherein the event comprises activating a warning light (170) arranged in connection to the drilling machine (120), and/or changing at least one out of the tangential velocity and/or the applied drill bit pressure to a combination outside of the undesired operating region.

17. The drilling machine (120) according to any previous claim, wherein the tag reader (125) is connected to the reader coil (220) via a variable impedance matching network, wherein the drilling machine control unit (140) and/or the tag reader (125) is arranged to control the variable impedance network to optimize the inductive coupling between the reader coil (220) and the tag coil (210).

18. The drilling machine (120) according to any previous claim, wherein the drilling machine control unit (140) is arranged to determine and to store drill bit usage information related to any of drill time, drill bit applied pressure, vibration, and temperature associated with the drill bit (110).

19. The drilling machine (120) according to claim 18, wherein the drilling machine control unit (140) is arranged to update a data base entry associated with the drill bit (110) stored in a remote server (160) and/or stored in a wireless device (150).

20. The drilling machine (120) according to any of claims 18-19, wherein the drilling machine control unit (140) is arranged to send the drill bit usage information to a memory device comprised in the tag (115), via the inductive coupling between the reader coil (220) and the tag coil (210).

21. The drilling machine (120) according to any previous claim, wherein the drilling machine control unit (140) is arranged to execute an authentication procedure based on the data associated with the drill bit (110) read via the inductively coupled reader and tag coils, thereby preventing unauthorized use of the drilling machine and/or unauthorized use of the drill bit.

22. A drill bit (110) comprising a drill bit interface (111) for interfacing with a spindle comprised in a drilling machine (120) and for rotating about an axle of rotation (101),
the drill bit (110) comprising a tag (115) connected to a tag coil (210) arranged at the drill bit interface (121), wherein the tag coil (210) surrounds the axle of rotation to inductively couple to a reader coil (220) arranged on the drilling machine (120) surrounding the spindle,
wherein the tag (115) is arranged to transmit data to the reader coil (220) via the tag coil (210).

23. The drill bit (110) according to claim 22, wherein the drill bit is a core drill bit comprising cutting segments (112) associated with a tangential velocity.

24. The drill bit (110) according to claim 22 or 23, wherein the drill bit interface (111) comprises at least two opposing parallel surfaces (240) extending parallel to the axle of rotation (101), wherein the parallel surfaces are arranged to engage with a spanner or wrench for attaching the drill bit (110) to the drilling machine (120).

25. The drill bit (110) according to any of claims 22-24, wherein the tag coil (210) is arranged asymmetrically about the axle of rotation (101).

26. The drill bit (110) according to any of claims 22-25, wherein the tag coil (210) comprises an electrically conducting element (310) arranged in-between at least part of the tag coil (210) and an axle of the drill bit.

27. The drill bit (110) according to any of claims 22-26, wherein the tag coil (210) is arranged for radio frequency identification, RFID, communication in a 13.56 MHz RFID frequency band.

28. The drill bit (110) according to any of claims 22-27, wherein the tag coil (210) is arranged to generate an H-field having an asymmetric field strength about the axle of rotation (101).

29. The drill bit (110) according to any of claims 22-28, wherein the tag coil (210) is wound along an asymmetric path about the axle of rotation (101).

30. The drill bit (110) according to any of claims 22-29, wherein the tag (115) is arranged to transmit information related to any of; a dimension and/or a diameter of the drill bit (110), a usage specification of the drill bit, a specification or property of the cutting segments of the drill bit, a temperature of the drill bit, a measured vibration level, and identification data, ID, associated with the drill bit, to the drilling machine (120) via the inductive coupling between the tag coil (210) and the reader coil (220) arranged on the drilling machine (120).

31. The drill bit (110) according to any of claims 22-30, wherein the tag (115) is arranged to determine and/or to store drill bit usage information associated with the drill bit (110), wherein the usage information is related to any of drilling time, drill bit applied pressure, drill bit tangential velocity, measured vibration, and measured temperature associated with the drill bit (110).

32. The drill bit (110) according to any of claims 22-31, wherein the tag (115) is arranged to receive drill bit usage information via the inductive coupling between the reader coil (220) and the tag coil (210), and to store the usage information in a memory device arranged on the drill bit (110).

33. The drill bit (110) according to any of claims 22-32, wherein the tag (115) is arranged to execute an authentication procedure upon request from the drilling machine (120), thereby preventing unauthorized use of the drilling machine and/or unauthorized use of the drill bit.

34. Core drilling equipment comprising a drilling machine (120) according to any of claims 1-21, and a drill bit (110) according to any of claims 22-33.

35. An inventory management system for managing a plurality of drilling machines (120) according to any of claims 1-21 and/or a plurality of core drill bits (110) according to any of claims 22-33, the inventory management system comprising a remote server (150) configured to receive update messages relating to use of the drilling machines and/or the drill bits, and to maintain a record of use of the drilling machines and/or of the drill bits.

36. The inventory management system according to claim 35, wherein the record of use comprises information related to any of identification data, ID, associated with a drill bit unit, a dimension and/or a diameter of the drill bit unit, a usage specification of the drill bit unit, a specification or property of the cutting segments of the drill bit unit, a measured temperature associated with the drill bit unit, and a measured vibration level associated with the drill bit unit.

37. A method for operating a core drill (100) comprising a motor arranged to power a spindle, the spindle comprising a drill bit interface (121) arranged to hold a drill bit (110) and to rotate the drill bit about an axle of rotation (101),
the method comprising
arranging a tag reader (125) connected to a reader coil (220) on the core drill (100), wherein the reader coil (220) is arranged at the drill bit interface (121) and surrounding the spindle to inductively couple to a tag coil (210) arranged around a drill bit shaft,
connecting a control unit (140) of the core drill (100) to the tag reader (125),
configuring (Sa1) a desired cutting segment tangential velocity,
obtaining (Sa2) a diameter associated with the drill bit (110) via the inductively coupled tag and reader coils (220, 210), and
setting (Sa3) a spindle rotation speed of the drilling machine (120), by the control unit (140), in dependence of the obtained diameter to obtain the desired tangential velocity.

38. A method for operating a core drill (100) comprising a motor arranged to power a spindle, the spindle comprising a drill bit interface (121) arranged to hold a drill bit (110) and to rotate the drill bit about an axle of rotation (101),
the method comprising
arranging a tag reader (125) connected to a reader coil (220) on the core drill (100), wherein the reader coil (220) is arranged at the drill bit interface (121) and surrounding the spindle to inductively couple to a tag coil (210) arranged around a drill bit shaft,
connecting a control unit (140) of the core drill (100) to the tag reader (125),
obtaining (Sb1) a drill bit applied pressure acting on a drill bit (110) of the core drill (100),
determining (Sb2) a cutting segment tangential velocity associated with the drill bit (110) at least partly based on a diameter value of the drill bit (110) obtained via the inductively coupled tag and reader coils (220, 210),
estimating (Sb3) a risk of cutting segment glazing based on the drill bit applied pressure and on the cutting segment tangential velocity, and
if the estimated risk of cutting segment glazing is above a threshold,
controlling (Sb4) at least one of the drill bit applied pressure and the cutting segment tangential velocity to reduce the risk of cutting segment glazing.

39. A method for operating a core drill (100) comprising a motor arranged to power a spindle, the spindle comprising a drill bit interface (121) arranged to hold a drill bit (110) and to rotate the drill bit about an axle of rotation (101), the method comprising
arranging a tag reader (125) connected to a reader coil (220) on the core drill (100), wherein the reader coil (220) is arranged at the drill bit interface (121) and surrounding the spindle to inductively couple to a tag coil (210) arranged around a drill bit shaft,
connecting a control unit (140) of the core drill (100) to the tag reader (125), obtaining (Sc1) identification data, ID, associated with the drill bit (110) by the control unit (140) via the inductively coupled tag and reader coils (220, 210),
determining (Sc2) drill bit usage information associated with the drill bit (110), wherein the usage information is related to any of drilling time, drill bit applied pressure, drill bit tangential velocity, measured vibration, and measured temperature,
associating (Sc3) the drill bit usage information with the obtained ID, and
updating (Sc4) a data base entry associated with the drill bit (110) ID at a remote server (160) and/or at a wireless device (150), based on the drill bit usage information.
